(19) United States
(12) Patent Application Publication
(10) Pub. No.: US 2026/0161163 A1
(43) Pub. Date: Jun. 11, 2026

(54) VEHICLE CONTROL SYSTEM AND VEHICLE CONTROL METHOD

(71) Applicant: TOYOTA JIDOSHA KABUSHIKI KAISHA, Toyota-shi (JP)

(72) Inventors: Naoya KANEKO, Tokyo (JP); Toru FURUSAWA, Yokohama-shi (JP); Kiminobu MAKINO, Tokyo (JP); Shota MISHIMA, Tokyo (JP); Haruka FUTATSUBASHI, Tokyo (JP)

(73) Assignee: TOYOTA JIDOSHA KABUSHIKI KAISHA, Toyota-shi (JP)

(21) Appl. No.: 19/396,017

(22) Filed: Nov. 20, 2025

(30) Foreign Application Priority Data
Dec. 6, 2024 (JP) 2024-213196

(51) Int. Cl. G05D 1/224; G05D 1/227; G05D 109/10; G06F 40/10

(52) U.S. Cl. CPC G05D 1/2247; G05D 1/227; G06F 40/10; G05D 2109/10

(57) ABSTRACT

A vehicle control system according to the present disclosure includes an environment information acquirer, a determiner, and a transmitter. The environment information acquirer is configured to acquire environment information regarding an environment around a vehicle. The determiner is configured to determine whether the environment around the vehicle needs to be confirmed by a monitoring operator based on the environment information. The transmitter is configured to transmit, in a case where the determiner has determined that the environment around the vehicle needs to be confirmed by the monitoring operator, a notification to the monitoring operator.

### CROSS-REFERENCE TO RELATED APPLICATION

This application claims priority to Japanese Patent Application No. 2024-213196 filed on Dec. 6, 2024. The disclosure of the above-identified application, including the specification, drawings, and claims, is incorporated by reference herein in its entirety.

### BACKGROUND

### 1. Technical Field

The present disclosure relates to a vehicle control system and a vehicle control method.

### 2. Description of Related Art

Japanese Unexamined Patent Application Publication No. 2024-018248 (JP 2024-018248 A) discloses a remote monitoring system. The remote monitoring system receives moving image data output by a network camera in real time, and generates distribution data by converting the moving image data with one or more parameters. Further, the remote monitoring system records the moving image data to generate record data and outputs distribution data to an external device in real time.

### SUMMARY

Even in a case where a vehicle is caused to drive by using autonomous driving, the remote monitoring system as described in JP 2024-018248 A may be introduced. In such a case, for example, it is assumed that a video around the vehicle is transmitted to an external monitoring operator, and the monitoring operator monitors the transmitted video.

However, in a case where the remote monitoring as described above is executed, a situation around the vehicle needs to be always transmitted to the monitoring operator, and thus, there is a possibility that communication costs are increased. That is, in the remote monitoring of the autonomous driving, there is a problem that the communication costs cannot be sufficiently reduced. JP 2024-018248 A does not disclose a technique that can solve such a problem.

The present disclosure has been made to solve such a problem, and an object of the present disclosure is to provide a vehicle control system and a vehicle control method capable of reducing the communication costs.

The vehicle control system according to the present disclosure includes an environment information acquirer, a determiner, and a transmitter. The environment information acquirer is configured to acquire environment information regarding an environment around a vehicle. The determiner is configured to determine whether the environment around the vehicle needs to be confirmed by a monitoring operator based on the environment information. The transmitter is configured to transmit, in a case where the determiner has determined that the environment around the vehicle needs to be confirmed by the monitoring operator, a notification requesting the monitoring operator to confirm the environment around the vehicle.

With such a configuration, there is no need to always transmit the situation around the vehicle to the monitoring operator. As a result, the vehicle control system according to the present disclosure can reduce the communication costs.

The vehicle control system according to the present disclosure may further include a vehicle controller configured to control the vehicle such that a mode is switchable between an autonomous driving mode for executing autonomous driving of the vehicle and a remote operation mode for executing driving of the vehicle based on a remote operation by the monitoring operator.

In the vehicle control system according to the present disclosure, the determiner may include a text converter and a text determiner. The text converter is configured to convert the environment information into text data. The text determiner is configured to determine, by reading the text data, whether the environment around the vehicle needs to be confirmed by the monitoring operator.

In the vehicle control system according to the present disclosure, the transmitter may be configured to transmit the text data converted from the environment information to the monitoring operator.

A vehicle control method according to the present disclosure is a vehicle control method including
acquiring environment information regarding an environment around a vehicle,
determining whether the environment around the vehicle needs to be confirmed by a monitoring operator based on the environment information, and
transmitting, in a case where a determiner has determined that the environment around the vehicle needs to be confirmed by the monitoring operator, a notification requesting the monitoring operator to confirm the environment around the vehicle.

According to the present disclosure, it is possible to provide a vehicle control system and a vehicle control method capable of reducing monitoring costs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a vehicle control system according to a first embodiment;

FIG. 2 is a block diagram showing a configuration of an in-vehicle system according to the first embodiment;

FIG. 3 is a block diagram showing a configuration of a determiner according to the first embodiment; and

FIG. 4 is a flowchart showing an operation of the vehicle control system according to the first embodiment.

### DETAILED DESCRIPTION OF EMBODIMENTS

### First Embodiment

### Configuration of Vehicle Control System

Hereinafter, a first embodiment of the present disclosure will be described in detail with reference to the drawings. First, a configuration of a vehicle control system according to the present embodiment will be described in detail.

A vehicle control system 100 according to the present embodiment is a system that controls an operation of a vehicle driven by autonomous driving. The vehicle control system 100 according to the present embodiment includes an in-vehicle system 1 and a remote monitoring center 2.

The remote monitoring center 2 monitors the operation of the vehicle controlled by the vehicle control system 100. The remote monitoring center 2 is a facility including a communication device for executing communication with the vehicle to be controlled and a display device for displaying at least a situation around the vehicle to a monitoring operator. A monitoring operator who monitors the operation of the vehicle is stationed at the remote monitoring center 2, and the monitoring operator executes control of the vehicle as needed.

In addition, the remote monitoring center 2 may include a computer device for outputting control information for the vehicle in a case where the operation of the vehicle is controlled by a remote operation to be described later.

The computer device described herein is a computer device that outputs control information of a vehicle to be controlled based on an operation of a monitoring operator. The computer device may include at least one processor and a memory, and the processor may execute a program stored in the memory to realize the function.
In addition, the control information is information that specifies the operation of the vehicle output based on the operation of the monitoring operator. Although details will be described later, the in-vehicle system 1 reads the control information transmitted from the remote monitoring center 2 to execute the operation based on the operation of the monitoring operator in the vehicle.

The in-vehicle system 1 is a system mounted on a vehicle that is a control target of the vehicle control system 100 according to the present embodiment, and is realized as, for example, one or more computer devices.

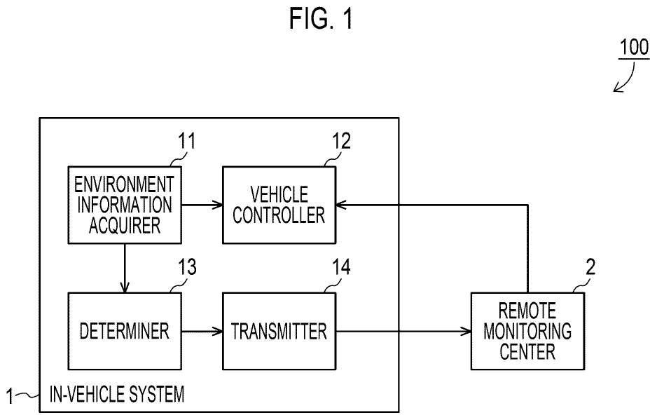

The in-vehicle system 1 controls an operation of a vehicle to be controlled. In addition, the in-vehicle system 1 executes communication with the remote monitoring center 2 as needed.
As shown in FIG. 1, the in-vehicle system 1 according to the present embodiment includes an environment information acquirer 11, a vehicle controller 12, a determiner 13, and a transmitter 14.

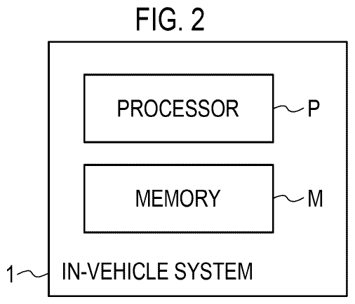

FIG. 2 is a block diagram showing a configuration of an in-vehicle system according to the first embodiment. More specifically, FIG. 2 is a block diagram showing a device configuration of an in-vehicle system according to the first embodiment.

As shown in FIG. 2, the in-vehicle system 1 according to the present embodiment includes a processor P and a memory M. The processor P is various processors, such as a central processing unit (CPU), a graphics processing unit (GPU), or a field-programmable gate array (FPGA). The memory M is a main storage device realized by using a random-access memory (RAM), a read-only memory (ROM), or the like. The processor P reads out and executes various programs recorded in the memory M to execute the functions as the functional blocks shown in FIG. 1.

The program includes an instruction set (or a software code) that causes the computer to perform one or a plurality of functions described in the embodiments when the computer reads the program. The program may be stored on a non-transitory computer-readable medium or a tangible storage medium. As a non-limiting example, the computer-readable medium or the tangible storage medium includes a random-access memory (RAM), a read-only memory (ROM), a flash memory, a solid-state drive (SSD), or other memory technologies. Examples of the computer-readable medium or the tangible storage medium include a CD-ROM, a digital versatile disc (DVD), a Blu-ray (registered trademark) disc, or other optical disc storages. In addition, the computer-readable medium or the tangible storage medium includes, as another example, a magnetic cassette, a magnetic tape, a magnetic disk storage, or other magnetic storage devices. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to the examples.

The in-vehicle system according to the aspect of the present disclosure may be implemented as a single device or may be implemented by causing a plurality of computer devices to cooperate with each other. In other words, the in-vehicle system 1 according to the present disclosure may be a system including one or more processors and one or more memories, in which the one or more processors may execute functions as functional blocks shown in FIG. 1.

Returning to the description of FIG. 1.

The environment information acquirer 11 acquires environment information regarding the environment around the vehicle. The environment information acquirer 11 outputs the acquired environment information to the vehicle controller 12 and the determiner 13.
The environment information referred to here is, for example, information acquired by a camera, a microphone, or an acceleration sensor, around the vehicle to be controlled. The environment information may be any information as long as the information is obtained by detecting a range in which the driving of the vehicle by autonomous driving is affected by the one or more sensors.

The vehicle controller 12 controls an operation of a vehicle to be controlled. More specifically, the vehicle controller 12 is configured to control the vehicle to be switchable between an autonomous driving mode for executing autonomous driving of the vehicle and a remote operation mode for executing driving of the vehicle based on a remote operation by the monitoring operator.

In the autonomous driving mode, the vehicle controller 12 acquires the environment information from the environment information acquirer 11. The vehicle controller 12 controls the operation of the vehicle based on the acquired environment information.

In the autonomous driving mode, the vehicle controller 12 controls the operation of the vehicle, for example, by outputting a control instruction value of an actuator group that drives the vehicle based on the environment information.

In the remote operation mode, the vehicle controller 12 acquires the control information transmitted from the remote monitoring center 2. The vehicle controller 12 controls the operation of the vehicle based on the acquired control information.

Here, as described above, the control information transmitted from the remote monitoring center 2 according to the present embodiment is the information output based on the operation of the monitoring operator. Therefore, the vehicle controller 12 can execute the driving of the vehicle based on the remote operation by the monitoring operator by executing the control of the operation of the vehicle based on the control information.

The vehicle controller 12 according to the present embodiment switches from the autonomous driving mode to the remote operation mode in a case where a notification of switching to the remote operation mode is received from the remote monitoring center 2 during the execution of the autonomous driving mode.

That is, the vehicle controller 12 according to the present embodiment executes the control of the vehicle by using the autonomous driving mode in a case where the notification is not received from the remote monitoring center 2. Further, the vehicle controller 12 according to the present embodiment executes the control of the vehicle by using the remote operation mode in a case where the notification is received from the remote monitoring center 2.
With such a configuration, in a case where the monitoring operator has determined that the driving operation by a person is needed, the control of the vehicle by a person can be appropriately switched from the control of the vehicle by autonomous driving.

The determiner 13 acquires the environment information from the environment information acquirer 11. The determiner 13 determines whether the environment around the vehicle needs to be confirmed by the monitoring operator based on the environment information.

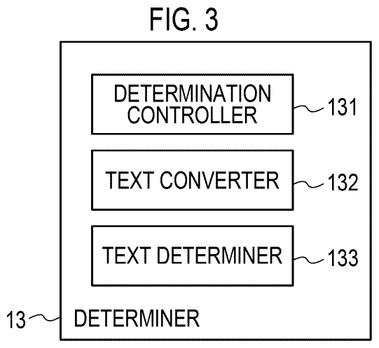

FIG. 3 is a block diagram showing a configuration of a determiner according to the first embodiment. As shown in FIG. 3, the determiner 13 includes a determination controller 131, a text converter 132, and a text determiner 133.

The determination controller 131 acquires the environment information from the environment information acquirer 11. Then, the acquired environment information is output to the text converter 132.

The determination controller 131 acquires the text data converted by the text converter 132. The determination controller 131 outputs the acquired text data to the text determiner 133. The determination controller 131 acquires a determination result regarding whether the environment around the vehicle needs to be confirmed by the monitoring operator, from the text determiner 133. The determination controller 131 outputs the acquired determination result to the transmitter 14.

The text converter 132 converts the environment information acquired from the determination controller 131 into text data. The text converter 132 according to the present embodiment outputs the converted text data to the determination controller 131.

The text converter 132 according to the present embodiment inputs the acquired environment information to the large-scale language model. The text converter 132 outputs the input environment information to the large-scale language model as text data describing the input environment information.

The text determiner 133 acquires the text data from the determination controller 131. Then, the text determiner 133 determines whether the monitoring operator needs to confirm the environment around the vehicle by reading the acquired text data. The text determiner 133 outputs the determination result to the determination controller 131.

The text determiner 133 according to the present embodiment inputs the acquired text data to the large-scale language model. Then, the text determiner 133 causes the large-scale language model to output a determination result as to whether the environment around the vehicle described by the input text data needs to be confirmed by the monitoring operator.

The text determiner 133 may determine whether the read text data needs to be recorded.

In this case, the determination controller 131 executes recording or discarding of the text data based on the determination result of the text determiner 133. That is, the determination controller 131 records the text data in the memory M when the text determiner 133 has determined that the read text data needs to be recorded. In addition, the determination controller 131 deletes the text data when the text determiner 133 has determined that there is no need to record the read text data.

As described above, the determiner 13 according to the present embodiment converts the acquired environment information into text data and loads the converted text data into the large-scale language model to determine whether the monitoring operator needs to confirm the environment around the vehicle.

With such a configuration, it is possible to appropriately detect an abnormality that cannot be detected by threshold value monitoring or abnormal behavior check of the detection data by the sensor. That is, with the configuration as described above, the vehicle control system 100 according to the present embodiment can improve the detection accuracy of the abnormality that may affect autonomous driving of the vehicle.

The transmitter 14 acquires a determination result regarding whether the environment around the vehicle needs to be confirmed by the monitoring operator, from the determiner 13. The transmitter 14 transmits the notification requesting the confirmation of the environment around the vehicle to the monitoring operator in a case where the determiner has determined that the monitoring operator needs to confirm the environment around the vehicle.

More specifically, the transmitter 14 transmits the notification requesting the confirmation of the environment around the vehicle to the remote monitoring center 2 to transmit the notification to the monitoring operator. Note that the configuration of the transmitter according to the present disclosure is not limited thereto, and for example, the notification may be transmitted to the communication terminal having the monitoring operator. That is, as long as the transmitter 14 according to the present disclosure can appropriately transmit the notification to the monitoring operator, the transmitter 14 may have any configuration.

The monitoring operator who receives the notification from the transmitter 14 confirms the situation around the vehicle. In this case, the monitoring operator may confirm the environment information acquired by the environment information acquirer 11, or may confirm, for example, a video captured by the in-vehicle camera.

In addition, the monitoring operator who receives the notification from the transmitter 14 may be requested to confirm the text data output by the text converter 132. That is, the monitoring operator who receives the notification from the transmitter 14 may confirm the situation around the vehicle by confirming the text data describing the situation around the vehicle. In this case, the transmitter 14 may notify the monitoring operator of the text data output by the text converter 132.

As described above, the vehicle control system 100 according to the present embodiment is configured to determine whether the monitoring operator needs to confirm the environment around the vehicle based on the environment information around the vehicle. Then, the vehicle control system 100 according to the present embodiment is configured to transmit the notification to the monitoring operator in a case where the determination is made that the monitoring operator needs to confirm the environment around the vehicle.

With such a configuration, there is no need to always transmit the situation around the vehicle to the monitoring operator. As a result, the vehicle control system according to the present disclosure can reduce the communication costs.

In addition, the vehicle control system 100 according to the present embodiment converts the situation around the vehicle into text data and reads the converted text data into a large-scale language model to perform the determination.

With such a configuration, the vehicle control system 100 according to the present embodiment can improve the detection accuracy of the abnormality generated around the vehicle.

Further, the vehicle control system 100 according to the present embodiment may transmit the converted text data to the monitoring operator. With such a configuration, the monitoring operator can more appropriately grasp the situation around the vehicle.

### Operation of Vehicle Control System

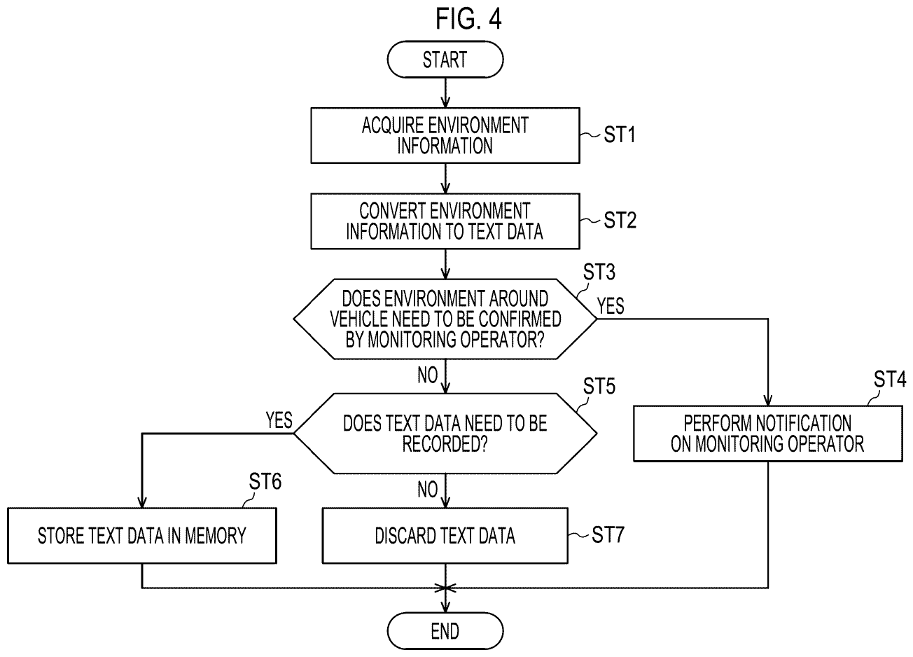

Next, the operation of the vehicle control system, that is, the vehicle control method according to the first embodiment will be described in detail. FIG. 4 is a flowchart showing an operation of the vehicle control system according to the first embodiment. In the following description, reference is made to FIGS. 1, 2, and 3 as appropriate.

In the processing procedure of FIG. 4, the processor P functions as the environment information acquirer 11, the vehicle controller 12, the determiner 13, and the transmitter 14 by reading out and executing the program from the memory M.

In the vehicle control method according to the first embodiment, first, the processor P acquires the environment information (ST1). That is, in ST1, the processor P functions as the environment information acquirer 11.

Next, the processor P converts the environment information into text data (ST2). That is, in ST2, the processor P functions as the determiner 13.

Next, the processor P determines whether the environment around the vehicle needs to be confirmed by the monitoring operator (ST3). That is, in ST3, the processor P functions as the determiner 13. More specifically, in ST3, the processor P reads the text data converted in ST2 into the large-scale language model to output the determination result.

When determination is made that the monitoring operator needs to confirm the environment around the vehicle (ST3YES), the processor P transmits the notification to the monitoring operator (ST4), and the vehicle control system 100 ends the series of operations. That is, in ST4, the processor P functions as the transmitter 14.

With such a configuration, there is no need to always transmit the situation around the vehicle to the monitoring operator. As a result, the vehicle control system according to the present disclosure can reduce the communication costs.

When determination is made that the monitoring operator does not need to confirm the environment around the vehicle (ST3NO), the processor P determines whether the text data needs to be recorded (ST5). That is, in ST5, the processor P functions as the determiner 13.

In a case where the processor P has determined that the text data needs to be recorded (ST5YES), the processor P stores the text data in the memory (ST6), and the vehicle control system 100 ends the series of operations. That is, in ST6, the processor P functions as the determiner 13.

In a case where the processor P has determined that there is no need to record the text data (ST5NO), the processor P stores the text data in the memory (ST7), and the vehicle control system 100 ends the series of operations. That is, in ST7, the processor P functions as the determiner 13.

As described above, the vehicle control system 100 according to the present embodiment is configured to determine whether the monitoring operator needs to confirm the environment around the vehicle based on the environment information around the vehicle. Then, the vehicle control system 100 according to the present embodiment is configured to transmit the notification to the monitoring operator in a case where the determination is made that the monitoring operator needs to confirm the environment around the vehicle.

With such a configuration, there is no need to always transmit the situation around the vehicle to the monitoring operator. As a result, the vehicle control system according to the present disclosure can reduce the communication costs.

Although the present disclosure has been described above in accordance with the embodiment, the present disclosure is not limited to the configuration of the embodiment, and of course includes various modifications, amendments, and combinations that can be made by a person skilled in the art within the scope of the disclosure of the claims of the present application.

What is claimed is:

1. A vehicle control system comprising:
an environment information acquirer configured to acquire environment information regarding an environment around a vehicle;
a determiner configured to determine whether the environment around the vehicle needs to be confirmed by a monitoring operator based on the environment information; and
a transmitter configured to transmit, in a case where the determiner has determined that the environment around the vehicle needs to be confirmed by the monitoring operator, a notification requesting the monitoring operator to confirm the environment around the vehicle.

2. The vehicle control system according to claim 1, further comprising a vehicle controller configured to control the vehicle such that a mode is switchable between an autonomous driving mode for executing autonomous driving of the vehicle and a remote operation mode for executing driving of the vehicle based on a remote operation by the monitoring operator.

3. The vehicle control system according to claim 1, wherein the determiner includes
a text converter configured to convert the environment information into text data, and
a text determiner configured to determine, by reading the text data, whether the environment around the vehicle needs to be confirmed by the monitoring operator.

4. The vehicle control system according to claim 3, wherein the transmitter notifies the monitoring operator of the text data converted from the environment information.

5. A vehicle control method comprising:
acquiring environment information regarding an environment around a vehicle;
determining whether the environment around the vehicle needs to be confirmed by a monitoring operator based on the environment information; and
transmitting, in a case where a determiner has determined that the environment around the vehicle needs to be confirmed by the monitoring operator, a notification requesting the monitoring operator to confirm the environment around the vehicle.
